(19) United States
(12) Patent Application Publication
(10) Pub. No.: US 2004/0244061 A1
(43) Pub. Date: Dec. 2, 2004

(54) Transmission and reception apparatus, receiver, and reproduction method

(76) Inventors: Nobutaka Okuyama, Yokohama (JP); Satoshi Mio, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/807,238

(22) Filed: Mar. 24, 2004

(30) Foreign Application Priority Data
Jun. 2, 2003 (JP) 2003-156124

(51) Int. Cl. H04N 7/173; G06F 13/00; H04N 5/445; G06F 3/00; H04H 9/00; H04N 7/16

(52) U.S. Cl. 725/142; 725/135; 725/136; 725/37; 725/134

(57) ABSTRACT

A first video receiver is controlled to interrupt live watching of a television broadcast program; and thereafter, a second video receiver installed in another location can be controlled to continue display of the program from the interrupted point in the program.

There is digital video recorder server that is capable of communication between local and remote sets via a home network. When a move watching and listening function is commanded at the local set, a built-in digital video recorder starts recording the program in progress. When a command is received at the local set for shifting the watching of the program to the remote set thereafter, the local set reads the recorded program from the recording start point and delivers it to the remote set from the server for effecting time shift watching and listening to the program on the remote set.

### BACKGROUND OF THE INVENTION

Conventionally, time shift watching and listening apparatuses for networking include a time shift watching and listening apparatus having a tuner networked to a time shift watching and listening apparatus having no tuner (see JP-A No. 171466/2002, for example).

Further, a conventional recording information transfer apparatus stores manipulation information about user manipulations on a recording and reproduction apparatus and transmits that information to a networked terminal (see JP-A No. 148826/2001, for example).

### SUMMARY OF THE INVENTION

The present invention relates to a receiver and a reproduction method for time shift watching and listening via a home network.

In the above-mentioned JP-A No. 171466/2002, both time shift watching and listening apparatuses require times for time shift watching and listening to be specified individually when a user moves from one apparatus to the other for continuous watching and listening. The above-mentioned JP-A No. 148826/2001 needs to store manipulation information for the network use. In consideration for user's convenience, it is therefore an object of the present invention to provide a method for interrupting live watching and listening to a television program on a first receiver by means of move watching and listening, performing time shift watching and listening on a second receiver installed at a different place, and continuing the time shift watching and listening to the interrupted television program with easy operations.

To achieve the above-mentioned purpose, the present invention can link two apparatuses via a home network. Manipulation for the move watching and listening on a current apparatus starts recording a program in the process of live watching and listening on a built-in recording medium. Upon request for time shift watching and listening from the other apparatus, the recorded program is read from the record start point and is delivered to the other apparatus from a server part.

To achieve the above-mentioned purpose, the present invention can link two apparatuses via a home network. Manipulation for the move watching and listening on a current apparatus issues a recording command to the other apparatus and starts recording a program in the process of live watching and listening on a recording medium built in the other apparatus. Upon request for time shift watching and listening from the other apparatus, the recorded program is read from the record start point according to a command from the current apparatus.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a configuration of a digital video recorder home server according to embodiment 1 of the present invention;

FIG. 2 is an explanatory diagram showing execution of tasks according to embodiment 1 of the present invention;

FIG. 3 is an explanatory diagram showing execution of tasks according to embodiment 2 of the present invention;

FIG. 4 is an explanatory diagram showing execution of tasks according to embodiment 3 of the present invention;

FIG. 5 is an explanatory diagram showing a manipulation menu according to the present invention;

FIG. 6 is a flowchart showing operations of a digital video recorder home server 1a according to embodiment 1 of the present invention;

FIG. 7 is a flowchart showing operations of a digital video recorder home server 1b according to embodiment 1 of the present invention;

FIG. 8 is a flowchart showing operations of a digital video recorder home server 1a according to embodiment 2 of the present invention;

FIG. 9 is a flowchart showing operations of a digital video recorder home server 1b according to embodiment 2 of the present invention;

FIG. 10 is a flowchart showing operations of a digital video recorder home server 1a according to embodiment 3 of the present invention;

FIG. 11 is a flowchart showing operations of a digital video recorder home server 1b according to embodiment 3 of the present invention; and

FIG. 12 is an explanatory diagram showing a recording and reproducing method according to the present invention.

### DETAILED DESCRIPTION OF THE PREFERRED EMBODIMENTS

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications a fall within the ambit of the appended claims.

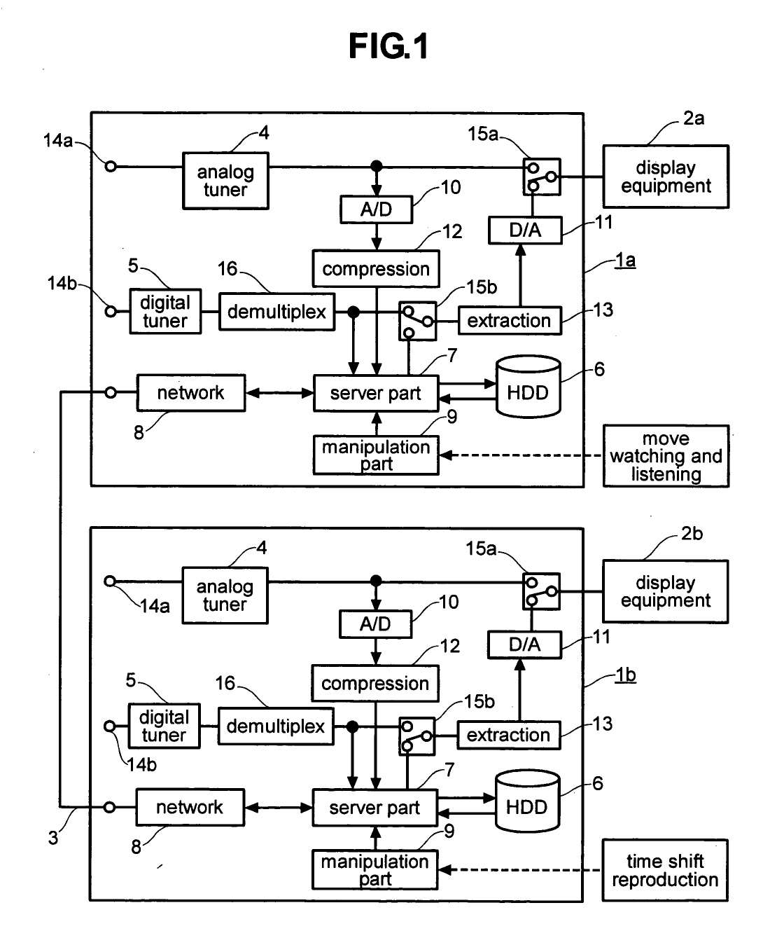

Embodiment 1. FIG. 1 is a block diagram showing a configuration of a digital video recorder home server according to embodiment 1 of the present invention. The configuration of FIG. 1 will be a basis for embodiments 2 and 3 to be described later. In FIG. 1, the reference numerals 1a and 1b denote digital video recorder home servers having the same configuration and are connected to each other via a home network 3. While the digital video recorder home server 1a (hereafter referred to as the first set) or 1b (hereafter referred to as the second set) is separated from display equipment 2a or 2b according to embodiment 1, they may be integrated into a single unit.

In FIG. 1, the reference numeral 4 represents an analog tuner, 5 a digital tuner, 6 a hard disk drive (abbreviated as HDD in the drawings) as a recording medium, 7 a server part, 8 a network part, 9 a manipulation part, 10 an A/D converter, 11 a D/A converter, 12 a compressor, 13 a decompressor, 14a an antenna terminal for analog broadcast, 14b an antenna terminal for digital broadcast, 15a and 15b signal selection switches, and 16 a demultiplexer.

To receive and display an analog broadcast as is, the switch 15a is selected so that output from the analog tuner is supplied to the display equipment 2a. To receive and display an digital broadcast as is, the demultiplexer 16 multiplexes output from the digital tuner 5 into a plurality of channel signals (also referred to as a service). One channel signal is separated from these signals. The switch 15b is selected so that the separated signal is supplied to the decompressor 13. Output from the decompressor 13 is supplied to the D/A converter 11 and is converted into an analog signal from the digital signal. The switch 15a is selected so that the converted signal is supplied to the display equipment 2a.

To record an analog broadcast, it passes through the A/D converter 10 and the compressor 12 to be converted into a compressed digital signal. The signal is supplied to the server part 7 and is recorded on the hard disk 6. To record a digital broadcast, it is directly supplied to the server part 7 and is recorded on the hard disk 6.

Let us consider a case where a user manipulates the manipulation part 9 for move watching and listening during live watching and listening to a broadcast program on the first set. In this case, the manipulation part 9 issues a recording instruction to the server part 7 to start recording the program in the process of live watching and listening on the hard disk. Here, it is more desirable to automatically turn off the display equipment.

Then, it is assumed that the user moves to a place where the second set is placed, and manipulates the manipulation 9 of the second set for time shift watching and listening. The manipulation part 9 issues a request for time shift watching and listening to the first set via the server part 7, the network part 8, and the home network 3.

The network part 8 of the first set transfers the request for time shift watching and listening to the server part 7. The server part 7 starts reading the program from the start point of the time shift recording and starts transmitting the recorded program to the second set via the network part 8 and the home network 3.

When received by the network part 8 in the second set, the program passes through the server part 7, the decompressor 13, and the D/A converter 11 to be converted into an analog signal and is reproduced and displayed on the display equipment.

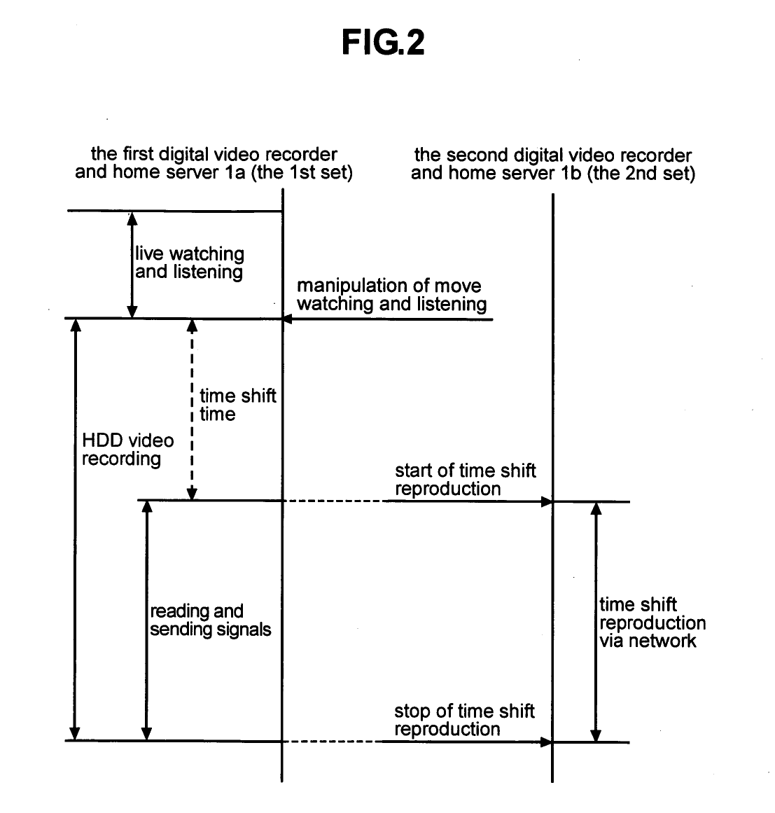

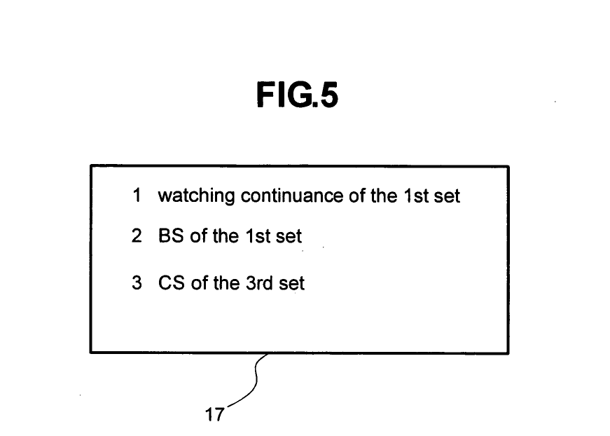

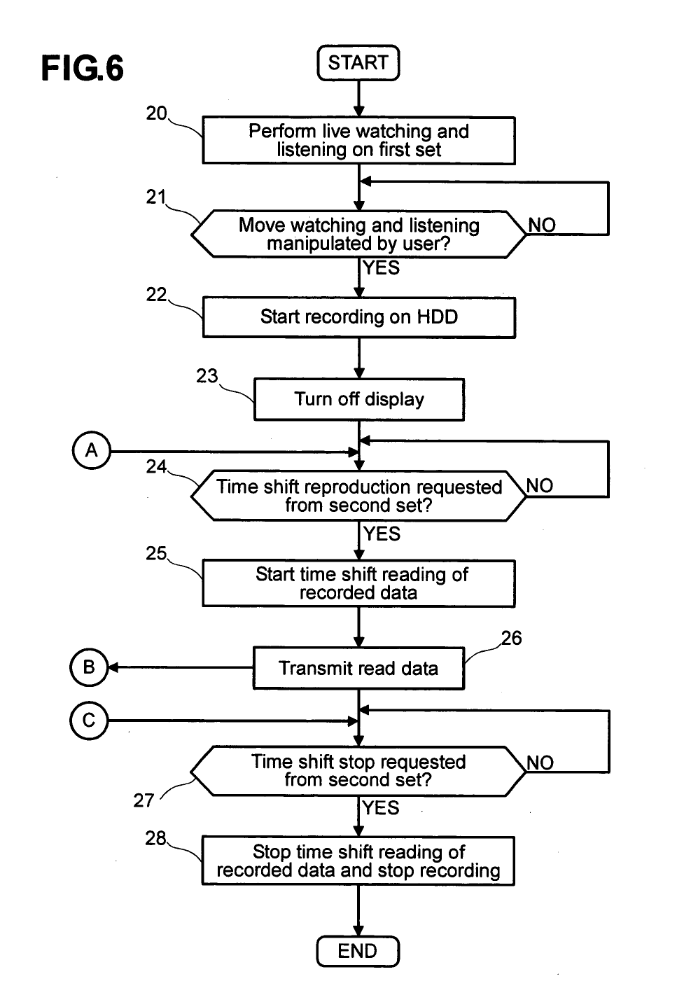

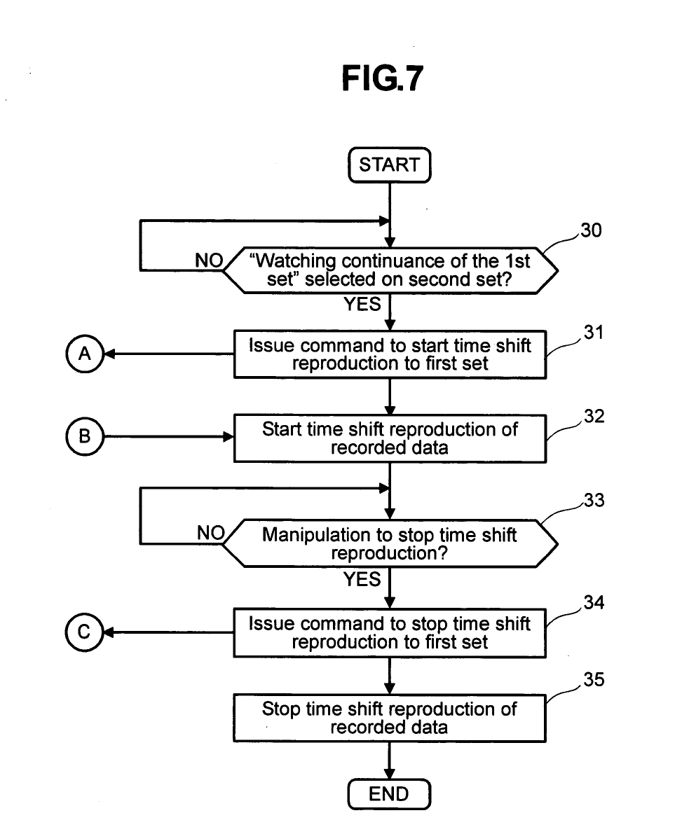

FIG. 2 is an explanatory diagram showing execution of tasks in the first and second sets according to embodiment 1. FIG. 6 is a flowchart for the first set. FIG. 7 is a flowchart for the second set. A user performs move watching and listening in the middle of live watching and listening to a broadcast on the first set (20 and 21). From the point of this manipulation, the first set starts recording the broadcast on the hard disk to record its recording position (22). The HDD or different memory may be used to record the recording position. The user turns off the display (23), moves to a room where the second set is placed, and then issues a command to start the time shift watching and listening (24). In this case, the user displays a manipulation menu in FIG. 5 immediately after the second set startup, and then selects the first option “watching continuance of the first set” from the menu (30). In the display example of the menu, the second option “BS of the first set” indicates that a live broadcast is to be received by communicating with a BS tuner of the first set. The third option “CS of the third set” indicates that a live broadcast is to be received by communicating with a CS tuner (not shown) connected to the home network. The command to start the time shift watching and listening is transmitted from the second set to the first set via the home network (31). The reference symbol A in the flowchart represents transmission and reception of this signal. In response to this signal, the first set reads the program recorded on the hard disk from the recording position corresponding to the move watching and listening manipulation (25). The first set then starts delivery to the second set (26). The reference symbol B in the flowchart represents transmission and reception of the signal for the program to be delivered. The second set reproduces the delivered program for time shift watching and listening (32). To end the watching and listening, the first set supplies the second set with a command to stop the time shift watching and listening (33). The command is transmitted to the first set via the home network (34 and 27). The reference symbol C in the flowchart represents transmission and reception of the signal for the time shift stop request. In response to this signal, the first set stops reading and delivering the program and recording on the hard disk (28). The reproduction on the second set also stops (35).

According to embodiment 1, a user enjoys live watching and listening to a television broadcast program halfway in a room where the first set is placed, and then performs the move watching and listening to temporarily interrupt the watching and listening. Afterward, the user moves to another room where the second set is placed, and then can continue watching and listening to the program from the interrupted point in a time shift manner.

The first set itself may continuously record a program in the process of live watching and listening for the purpose of time shift watching and listening. In this case, the above-mentioned can be applied by storing the recording position corresponding to the time point of the move watching and listening manipulation and maintaining the recording state.

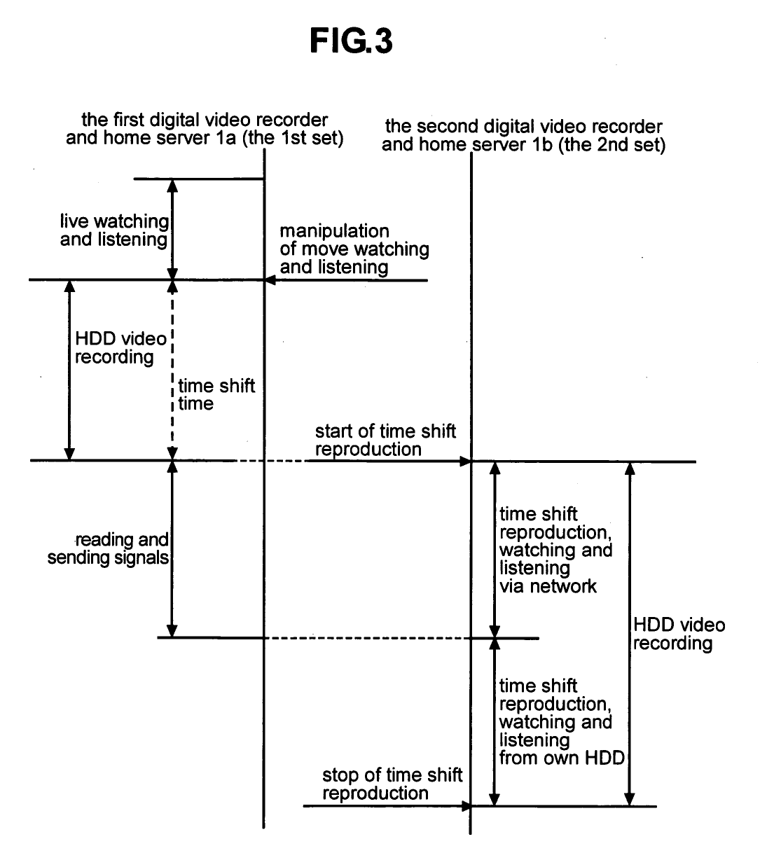

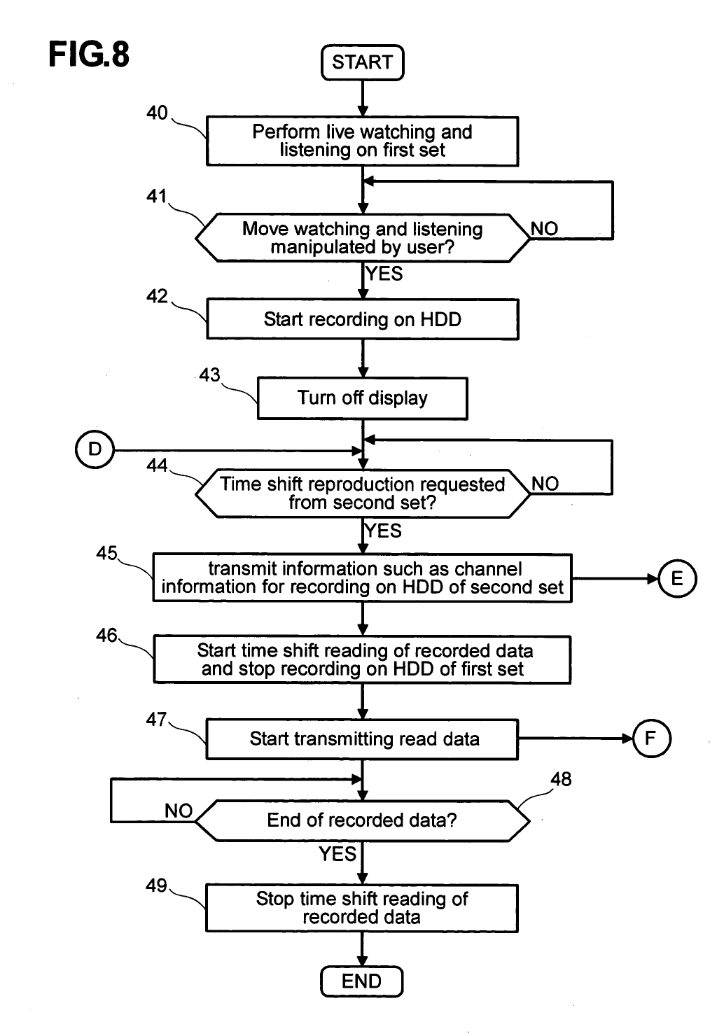

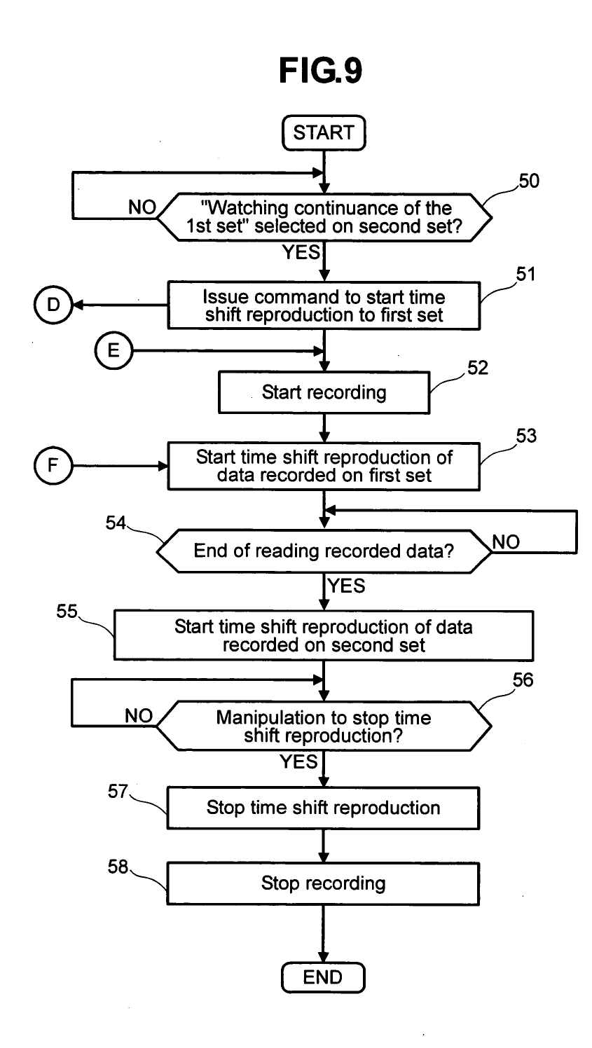

Embodiment 2. FIG. 3 is an explanatory diagram showing execution of tasks in the first and second sets according to embodiment 2. FIG. 8 is a flowchart for the first set. FIG. 9 is a flowchart for the second set. A user performs move watching and listening in the middle of live watching and listening to a broadcast program on the first set (40 and 41). The move watching and listening manipulation starts recording the broadcast program for the live watching and listening on the hard disk (42). The user turns off the display (43). The user then moves to a room where the second set is placed, and then issues a command to start the time shift watching and listening (50).

This command is transmitted from the second set to the first set via the home network 3 (51). The reference symbol D in the flowchart represents transmission and reception of this signal. In response to this signal (44), the first set transmits information (channel information and the like) for recording on the second set's HDD (45). The reference symbol E in the flowchart represents transmission and reception of the information such as channel numbers for starting the second hard disk recording. The first set reads the program recorded on the hard disk from the beginning and stops recording on its own HDD (46). In addition, the first set transmits the read data to the second set (47). Simultaneously with the start of this delivery, the second set starts recording the program on the hard disk (52). The reference symbol F in the flowchart represents transmission and reception of the signal for delivering the program recorded on the hard disk. In response to the delivery, the second set starts the time shift watching and listening of the recorded data from the first set (53). Upon completion of transmitting and reading the program recorded on the first set's hard disk (48, 49, and 54), the user enables the time shift watching and listening from the second set's hard disk to display the program (55). To end the watching and listening, the user stops the time shift watching and listening (56). The second set stops the time shift watching and listening and recording on the hard disk (57 and 58).

According to embodiment 2, a user enjoys live watching and listening to a television broadcast program halfway in a room where the first set is placed, and then issues a command for the move watching and listening to temporarily interrupt the watching and listening. Afterward, the user moves to another room where the second set is placed, and then can continue watching and listening to the program from the interrupted point in a time shift manner. It is also possible to finish using the first set early and allow the other users to use it.

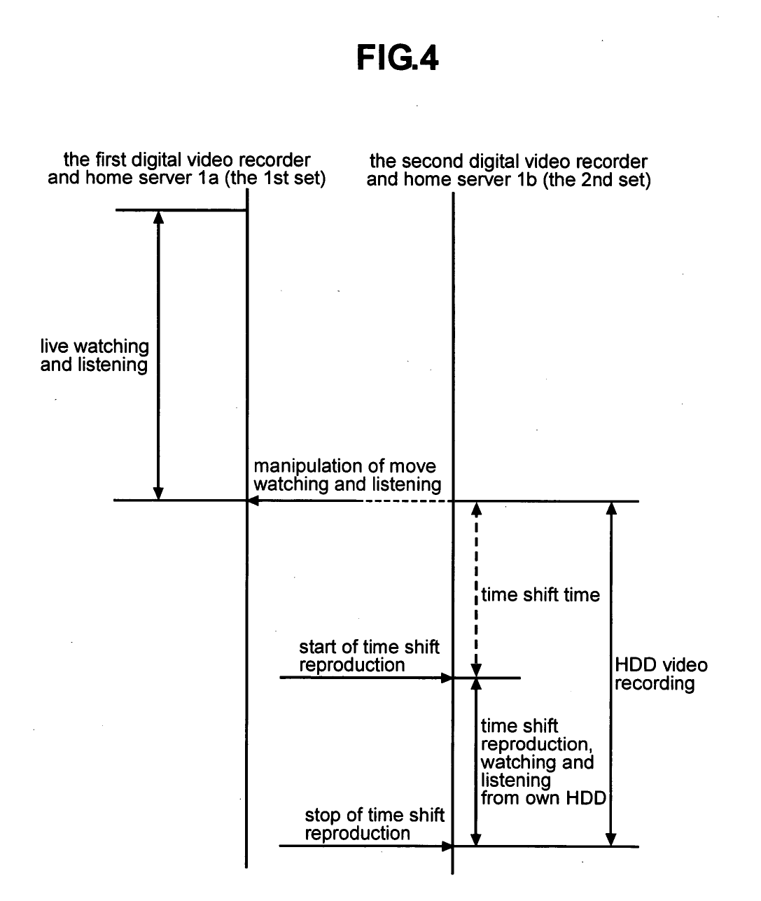

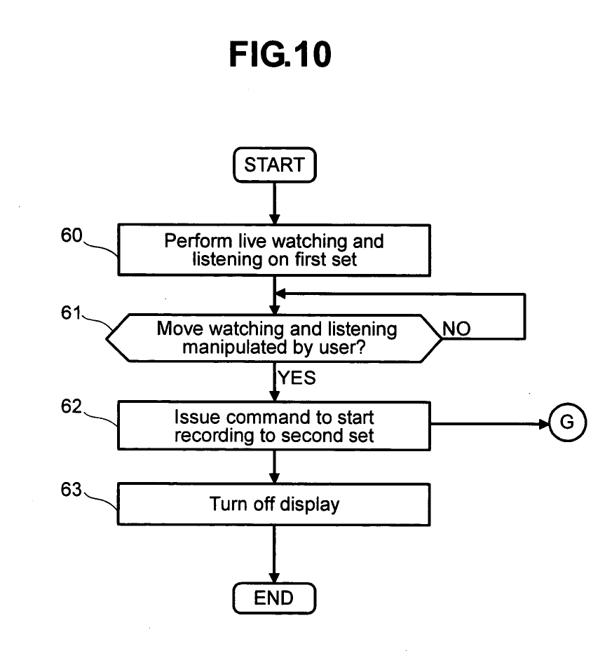

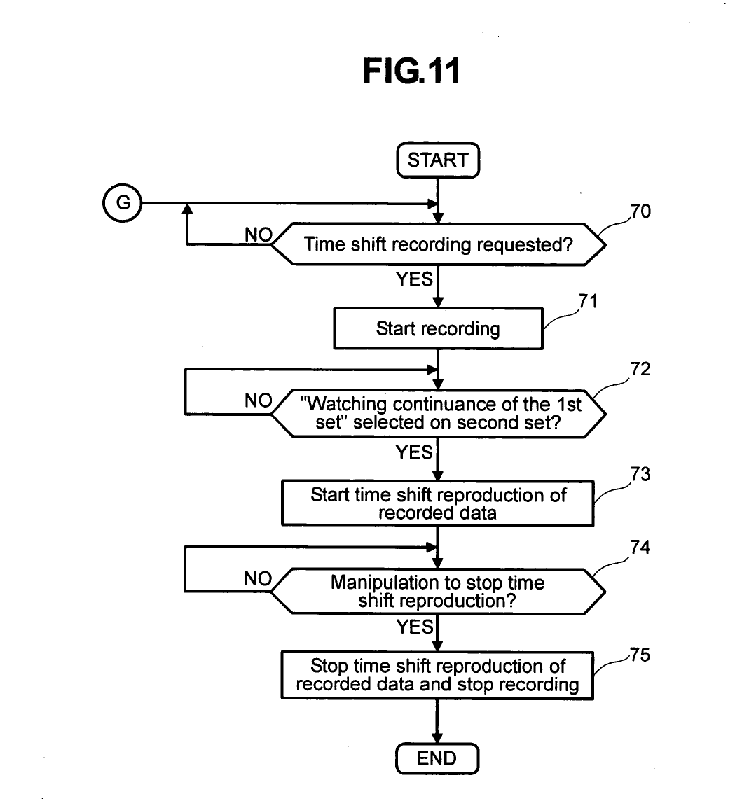

Embodiment 3. FIG. 4 is an explanatory diagram showing execution of tasks in the first and second sets according to embodiment 3. FIG. 10 is a flowchart for the first set. FIG. 11 is a flowchart for the second set. In the middle of live watching and listening to a broadcast program on the first set (60), the user manipulates move watching and listening (61). A signal for the manipulation is transmitted to the second set (62) together with channel information for the live watching and listening via a path marked with G in the flowchart. In response to the request for the time shift recording (70), the second set starts recording the program in the process of watching and listening on the hard disk for time shift watching and listening (71). The user turns off the first set (63). The user then moves to a room where the second set is placed, and then issues a command to start the time shift watching and listening on the second set (72). The user reads the program being recorded on the second set's hard disk from the beginning to start the time shift watching and listening (73). To end the watching and listening, the user issues a command to stop the time shift watching and listening (74). The second set stops the time shift watching and listening and recording on the hard disk (75).

According to embodiment 3, a user enjoys live watching and listening to a television broadcast program halfway in a room where the first set is placed, and then issues a command for the move watching and listening to temporarily interrupt the watching and listening. Afterward, the user moves to another room where the second set is placed, and then can continue watching and listening to the program from the interrupted point. It is also possible to finish using the first set immediately after issuing the command for the move watching and listening and allow the other users to fully use the first set.

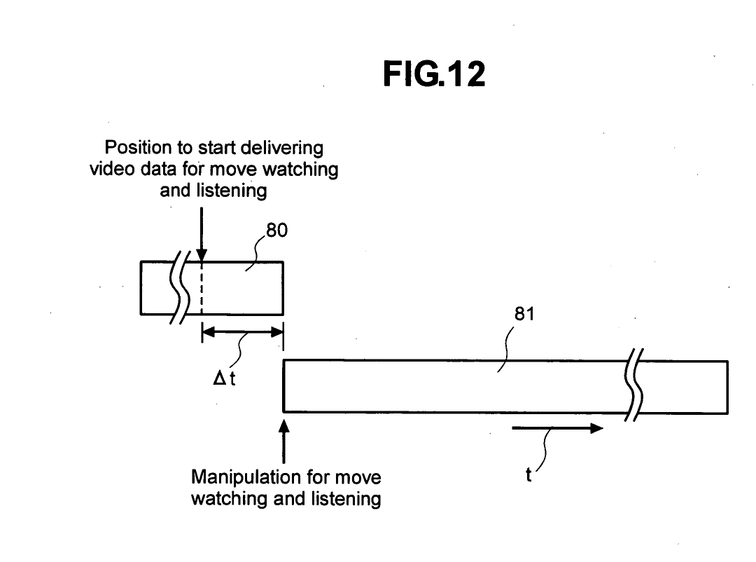

FIG. 12 is an explanatory diagram showing how to start the move watching and listening commonly applicable to embodiments 1 and 2 according to the present invention when a continuous recording apparatus is available. It is possible to provide a function to continuously record a specified period of a program that is being watched and listened. In this case, video data 80 before the move watching and listening manipulation is continuously updated and recorded in a small amount of memory or a specified storage area allocated to the HDD. In FIG. 12, an arrow t represents the direction of time. The video data 80 before the move watching and listening manipulation is recorded on the HDD. Accordingly, it is possible to specify time Δt and reproduce the video data from a time point Δt back from the time point of the move watching and listening manipulation. Thereafter, the video data 81 can be continuously delivered.

In this manner, the video data for move watching and listening may be retroactively delivered for a specified period of time from the time point of the move watching and listening manipulation instead of simultaneously with the time point thereof.

It is also possible to simultaneously provide the functions of the embodiments 1 through 3 for the corresponding servers and to allow the user to choose from the time shift watching and listening methods. As mentioned above, the present invention provides the following effect. After live watching and listening to a television broadcast program halfway in a room where the first set is placed, the user can issue a command for move watching and listening to temporarily interrupt the watching and listening. The user can then move to another room where the second set is placed, and continue the watching and listening to the program from the interrupted point in a time shift manner.

According to the present invention, it is possible to provide a user-friendly reproduction system.

1. A transmission and reception apparatus which operates to receive a video signal and transmit it to an external device, comprising:
a reception device which receives a video signal;
a recording device which records a video signal received by the reception device;
a transmission system on which a video signal recorded by the recording deice is transmitted to an external device via a network;
an output device which outputs a video signal to display a signal received by the reception device; and
an input unit responsive to user manipulation,
wherein, based on user manipulation from the input unit, the recording device records a video signal received after said user manipulation; and
wherein the output device stops video signal output and, in response to a request from the external device, transmits the video signal recorded by the recording device to the external device.

2. The transmission and reception apparatus according to claim 1, wherein the recording device stops the recording of a video signal after the transmission stem transmits a video signal.

3. The transmission and reception apparatus according to claim 1, wherein the transmission system transmits recording information about a received video signal to an external device via a network.

4. The transmission and reception apparatus according to claim 1,
wherein the reception device receives a digital broadcast signal including a compressed video signal, and
wherein the transmission system transmits a compressed video signal to an external device.

5. The transmission and reception apparatus according to claim 1, further comprising:
a memory which automatically stores a video signal received by the reception device,
wherein the transmission system transmits a video signal recorded by the recording device based on user manipulation and a video signal automatically stored in the memory before the recording device starts recording.

6. A transmission and reception apparatus which operates to receive a video signal and transmit it to an external device, comprising:
a reception device which receives a video signal;
a recording device which records a video signal received by the reception device;
a transmission system on which a video signal recorded by the recording device is transmitted to an external device via a network;
an output device which outputs a video signal to display a signal received by the reception device; and
an input unit responsive to user manipulation,
wherein, based on user manipulation from the input unit, the recording device records a video signal received after said user manipulation;
wherein recorded information at a time point of the user manipulation is transmitted to the external device; and
wherein, in response to a request from the external device, the video signal recorded by the recording device is transmitted to the external device.

7. A receiver which operates to receive and reproduce a signal transmitted from an external device having a recording device which records a video signal, comprising:
a reception device which receives a signal including a program transmitted by the external device and information about the program via a network;
a reproduction device which reproduces a signal received by the reception device; and
a recording device for receiving and recording a broadcast program,
wherein the recording device records a program based on information about the program transmitted from the external device.

8. The receiver according to claim 7,
wherein a program received by the reception device and a program recorded by the recording device constitute a sequence of contents.

9. The receiver according to claim 7,
wherein a signal transmitted from the external device contains a compressed digital video signal; and
wherein the reproduction device decompresses a received signal.

10. The receiver according to claim 7, further comprising:
an output device which outputs a list of signals which the reception device receives from the external device based on information from the external device.

11. The receiver according to claim 7, further comprising:
an input unit responsive to user manipulation,
wherein specified user manipulation stops recording of a video signal in the external device via the network and starts recording in the recording device.

12. A reproduction method of reproducing a video signal in a recording and reproduction apparatus and a receiver comprising the steps of:
reproducing a video signal in the recording and reproduction apparatus;
inputting specified user manipulation;
recording a video signal continued from a video signal reproduced by the reproducing step in the recording and reproduction apparatus, wherein the video signal to be recorded is contained in a video signal received after the user manipulation;
stopping reproduction of the video signal after the recording step;
requesting to read a video signal recorded in the recording and reproduction apparatus of the receiver;
transmitting a video signal following user manipulation to the receiver via a network in response to said requesting wherein the video signal to be transmitted is recorded in the recording and reproduction apparatus; and
receiving a video signal transmitted from the recording and reproduction apparatus of the receiver and reproducing the video signal.

13. The reproduction method according to claim 12, further comprising the steps of:
requesting to read a video signal recorded in the recording and reproduction apparatus of the receiver and then receiving a broadcast signal; and
reproducing a signal recorded in the receiver so as to continue from the contents of a video signal transmitted from the recording and reproduction apparatus.

14. The reproduction method according to claim 13,
wherein the step of receiving the broadcast signal includes recording a specified video signal based on recording information about a video signal received by the recording and reproduction apparatus.

15. The reproduction method according to claim 12,
wherein, in the recording and reproduction apparatus, the reproduction step receives and decodes a digital broadcast signal; and
wherein the recording step records a received digital broadcast signal.

16. The reproduction method according to claim 12, further comprising the step of:
allowing display equipment of the receiver to display names of a plurality of networked devices including the recording and reproduction apparatus capable of receiving a video signal.
